(19) United States
(12) Patent Application Publication
(10) Pub. No.: US 2006/0218681 A1
(43) Pub. Date: Sep. 28, 2006

(54) Moving-scaffold device with couplings for painting truss bridge

(76) Inventor: Kouichi Sakakibara, Gifu-ken (JP)

Correspondence Address: Sakakibara Kouichi, 1-103-1 Sugaminami Hotsu-cho Hashima-shi, Gifu-ken, 501-6335, JP

(21) Appl. No.: 10/545,983

(22) PCT Filed: Feb. 23, 2004
(86) PCT No.: PCT/JP04/02098

§ 371 Date: Aug. 18, 2005

(30) Foreign Application Priority Data
Feb. 24, 2003 (JP) 2003-108446

(51) Int. Cl. E06C 1/38

(52) U.S. Cl. D25/62

(57) ABSTRACT

A moving-scaffold device for painting a truss bridge has the scaffold and inner three-dimensional frames comprising a ceiling and both lateral surfaces with plural wheels at their feet to move at a low speed by driving powers.

### BACKGROUND OF THE INVENTION

1. Field of the Invention

This invention relates to a moving-scaffold device, with which the scaffolding is easily built up in a short time with the minimum cost and wood, and is moved to the next point while a truss bridge is painted, although it takes a lot of time to build up and put away the conventional scaffolding in scores of trucks (the longest one is over 1000M including waterproof tents) while it blocks traffic because of a public enterprise on a huge budget in most cases.

2. Description of the Related Art

Conventionally, it is very inefficient to build scaffolding for painting a truss bridge as the afore-mentioned, although public enterprises should cost time and money as little as possible.

### BRIEF SUMMARY OF THE INVENTION

It is an object of the invention to provide a moving-scaffold device with couplings for painting a truss bridge in the shortest time so as to minimize wood, labor costs and traffic jams, which will be a profitable business in the future.

According to a first aspect of the invention, there is provided a moving-scaffold device for painting a truss bridge which has the scaffold and inner three-dimensional frames comprising a ceiling and both lateral surfaces having plural wheels at their feet to move at a low speed by driving powers, linked with the scaffold and outer three-dimensional frames comprising a roof and both lateral surfaces having plural wheels underneath the roof to move at a low speed by driving powers, with plural couplings.

According to a second aspect of the invention, there is provided a moving-scaffold device for painting a truss bridge without wheels underneath the roof of the outer three-dimensional frames.

According to a third aspect of the invention, there is provided a moving-scaffold device for painting a truss bridge with waterproof on a part or all parts of the inner three-dimensional frames.

According to a fourth aspect of the invention, there is provided a moving-scaffold device for painting a truss bridge with waterproof on a part or all parts of the outer three-dimensional frames.

According to a fifth aspect of the invention, there is provided a moving-scaffold device for painting a truss bridge with waterproof on a part or all parts of the inner and outer three-dimensional frames.

According to a sixth aspect of the invention, there is provided a moving-scaffold device for painting a truss bridge with couplings each of which comprises a rotating coupling-bar with: the bending center having a concave piece and a convex piece for the joint; and the both ends having springs at the fulcrums on the outside surface of the inner three-dimensional frames and on the inside surface of the outer three-dimensional frames.

In the above-mentioned, a moving-scaffold device for painting a truss bridge during moves at a low speed, the inner and outer three-dimensional frames may have driving powers within the inside of them or they may be pulled by rope, etc. from the outside. When the inner three-dimensional frames are linked with the outer three-dimensional frames, the driving powers may be within the inside of the inner three-dimensional frames at the lower parts. The waterproof vinyl sheets, in general, on the ceiling of the inner three-dimensional frames must be needed to protect the surfaces and the cars passing under the scaffolding, etc. from wind, rain and paint. A few (at least) strong couplings that are operated sufficiently by hand during moves at a low speed are further needed for safety, while plural automatic couplings save time and trouble. ‘Moves at a slow speed’ in general means consecutive moves, but ‘moves at a slow speed’ in this invention may be successive enough to stop completely at one time, move a little at a low speed and stop again. When the automatic coupling hits an iron, etc. of the trusses, etc. during moves of the three-dimensional frames, the coupling-bar bends backward automatically and divides into the upper part and the lower part or into the right side and the left side on the inner and outer lateral surfaces. After the obstacles passing by, the upper part and the lower part or the right side and the left side of the coupling-bar are joined again by the pressure of the springs. The inside driving powers may be batteries, etc.

### BRIEF DESCRTION OF THE DRAWINGS

FIG. 1 is a partially explanatory front view showing how the inner three-dimensional frames are linked with the outer three-dimensional frames of a moving-scaffold device for painting a truss bridge.

FIG. 2 is a partially explanatory view of the lateral side of the moving-scaffold device for painting a truss bridge (showing how the inner three-dimensional frames are linked with the outer three-dimensional frames).

FIG. 3, (3-1) and (3-2), is a partially explanatory front view (or a side view) of a coupling of the moving-scaffold device for painting a truss bridge.

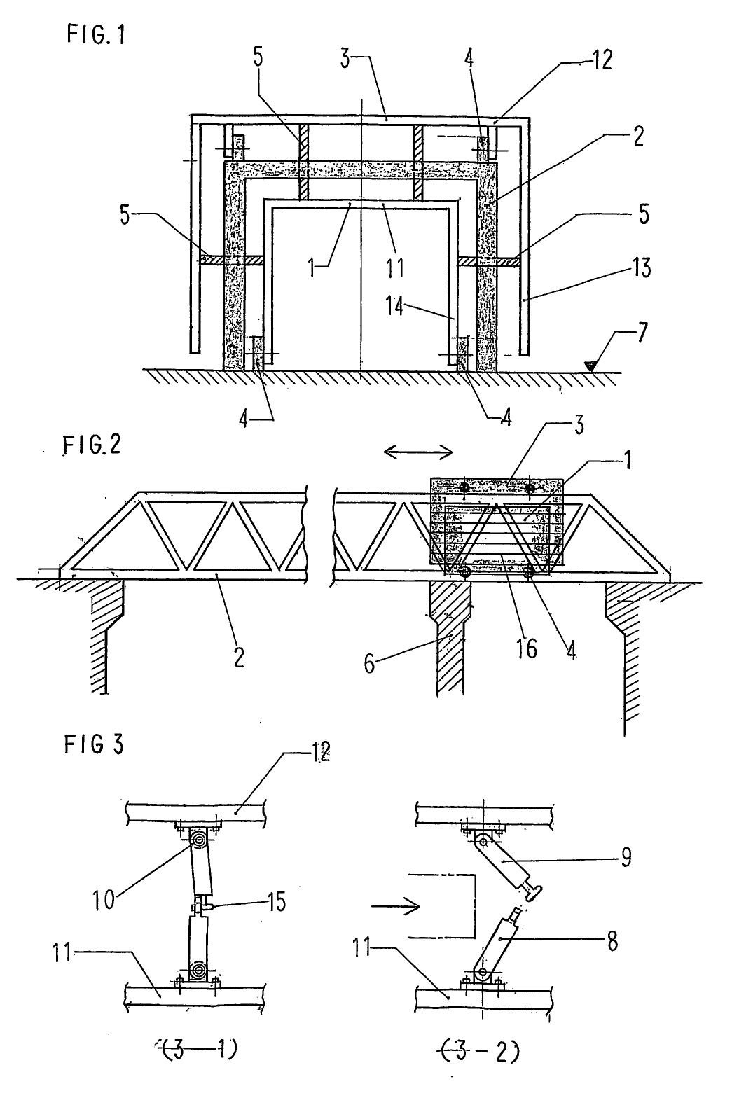

### ILLUSTRATIONS

1. inner three-dimensional frame
2. truss
3. outer three-dimensional frame
4. wheel
5. coupling
6. bridge girder
7. ground
8. concave piece
9. convex piece
10. rotating section with spring
11. ceiling
12. roof
13. outer lateral surface
14. inner lateral surface
15. joint section
16. scaffold

### DESCRIPTION OF THE PREFREERRED EMBODIMENTS

The narrower the spaces for painters to work enough between inner three-dimensional frames and a truss bridge are, the better the cars, etc. pass by under them. The narrower the spaces for the painters to work enough between outer three-dimensional frames and a truss bridge are, the stronger the linking with the inner three-dimensional frames is. Couplings are ideal to be placed at random as any forms of truss bridges have plural sets of couplings. As the afore-mentioned, speeds and ways to move the three-dimensional frames, ways of inside driving powers such as a motor-driven system with batteries and an engine-driven system, etc., ways of inside or outside driving powers such as with levers, etc. attached to a truss, and manual-types to reinforce the linking are optional. The length of 5M that is efficient for the scaffolding in general is also optional. Making use of handrails, balustrades, sidewalks and other things of bridges with wheels on the sides of the device is convenient to fix the width of the scaffolding and to move straight automatically. The waterproof on the three-dimensional frames may be changed according to the necessity. For example, only the roof of the outer three-dimensional frames may have waterproof for sunlight when it's not windy, etc. but sunny. The wheels of the outer three-dimensional frames may be further put according to the necessity. The afore-mentioned scaffold may also serve as a part of the three-dimensional frames according to ways of building the scaffolding.

Other Modifcations

As the afore-mentioned, painting a long truss bridge etc. needs a lot of works. So as to cut down the working hours, a few three-dimensional frames (about 5M) may be put together or used at plural points.

Consequently, this invention is expected not to waste taxes, not to take much time, to relieve the traffic congestion, and the like, which shows conventional faults clearly.

The preferred embodiments described herein are illustrative and not restrictive, the scope of the invention being indicated in the appended claims and all variations that come within the meaning of the claims are intended to be embraced therein.

1. A moving-scaffold device for painting a truss bridge, the scaffold and inner three-dimensional frames comprising a ceiling and both lateral surfaces with plural wheels at a low speed by driving powers, linked with the scaffold and outer three-dimensional frames comprising a roof and both lateral surfaces with plural wheels underneath the roof to move at a low speed by driving powers, with plural couplings.

2. A moving-scaffold device for painting a truss bridge, according to claim 1, in which the outer three-dimensional frames don't have the wheels underneath the roof.

3. A moving-scaffold device for painting a truss bridge, according to claim 1 or 2, in which a part or all parts of the inner three-dimensional frames have waterproof.

4. A moving-scaffold device for painting a truss bridge, according to claim 1, 2 or 3, in which a part or all parts of the outer three-dimensional frames have waterproof.

5. A moving-scaffold device for painting a truss bridge, according to claim 1, 2, 3, or 4, in which a part or all parts of the inner and outer three-dimensional frames have waterproof.

6. A moving-scaffold device for painting a truss bridge, according to claim 1, 2, 3, 4 or 5, in which each coupling comprises a rotating coupling-bar with: the bending center having a concave piece and a convex piece for the joint; and the both ends having springs at the fulcrums on the outside surface of the inner three-dimensional frames and on the inside surface of the outer three-dimensional frames.
